(19) United States
(12) Patent Application Publication
(10) Pub. No.: US 2024/0019117 A1
(43) Pub. Date: Jan. 18, 2024

(54) MASK WITH SEALING INDICATOR

(71) Applicant: Lenovo (Singapore) Pte. Ltd., New Tech Park (SG)

(72) Inventors: Robert J. Kapinos, Durham, NC (US); Scott Li, Cary, NC (US); Robert James Norton, JR., Raleigh, NC (US); Russell Speight VanBlon, Raleigh, NC (US)

(21) Appl. No.: 17/813,236

(22) Filed: Jul. 18, 2022

(51) Int. Cl. F21V 33/00; F21S 9/04; A62B 23/02

(52) U.S. Cl. CPC F21V 33/0064; F21S 9/04; A62B 23/025; F21Y 2115/10

(57) ABSTRACT

Apparatuses, methods, and systems are disclosed for providing an indication of properly wearing a mask. A mask device, in one embodiment, includes a flexible filtering screen configured to cover a mouth and a nose of a user, a power source disposed on the flexible filter screen, an output device configured to generate an output indication responsive to the power generated by the power source.

### FIELD

The subject matter disclosed herein relates to breathing masks and more particularly to providing indication of how a mask is being worn.

### BACKGROUND

Health related face masks will be with us for a long time. Ensuring a good mask seal is difficult.

### BRIEF SUMMARY

Apparatuses, methods, and systems are disclosed for providing an indication of properly wearing a mask.

A mask device, in one embodiment, includes a flexible filtering screen configured to cover a mouth and a nose of a user, a power source disposed on the flexible filter screen, an output device configured to generate an output indication responsive to the power generated by the power source.

A method, in one embodiment, includes generating an electrical current from a power source disposed on the flexible filter screen responsive to movement of the flexible filter screen, storing the generated electrical current in a storage device, discharging the stored electrical current responsive to the stored electrical current being greater than a threshold value, and outputting an indication responsive to the discharged electrical current.

A method, in another embodiment, includes attaching a power storage element to a piezoelectric element, attaching a controller to the power storage element; attaching an output device to the controller, and attaching the attached elements to a flexible section of a mask.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be limiting of scope, the embodiments will be described and explained with additional specificity and detail using the accompanying drawings, in which:

FIG. 1 is a front view of one embodiment of a mask being worn in accordance with an embodiment;

FIG. 2 is a schematic block diagram illustrating one embodiment of an apparatus;

FIG. 3 is a circuit diagram illustrating one embodiment used in the apparatus of FIG. 1;

FIG. 4 is a schematic flow chart diagram illustrating one embodiment of a method for making a mask;

FIG. 5 is a schematic flow chart diagram illustrating one embodiment of another method for using a mask;

FIG. 6 is a front view of one embodiment of a mask being worn in accordance with another embodiment; and

FIG. 7 is a perspective view of a mask made in accordance with another embodiment.

### DETAILED DESCRIPTION

As will be appreciated by one skilled in the art, aspects of the embodiments may be embodied as a system, method, or method of making.

Many of the functional units described in this specification have been labeled as circuit components. For example, a hardware circuit component may include custom very large scale integrated (“VLSI”) circuits or gate arrays, off-the-shelf semiconductors such as logic chips, transistors, microelectromechanical sensors/actuators, or other discrete components. A circuit component may also be implemented in programmable hardware devices such as a field programmable gate array (“FPGA”), programmable array logic, programmable logic devices or the like.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, and systems according to embodiments. It will be understood that each block of the schematic flowchart diagrams and/or schematic block diagrams, and combinations of blocks in the schematic flowchart diagrams and/or schematic block diagrams, can be implemented by code or various circuit components.

The schematic flowchart diagrams and/or schematic block diagrams in the figures illustrate the architecture, functionality, and operation of possible implementations of apparatuses, systems, and methods according to various embodiments. In this regard, each block in the schematic flowchart diagrams and/or schematic block diagrams may represent an action performed by functional components.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The apparatuses, methods, systems, and their respective embodiments disclosed herein facilitate and assist determining proper usage of a mask. The description of elements in each figure may refer to elements of proceeding figures. Like numbers refer to like elements in all figures, including alternate embodiments of like elements.

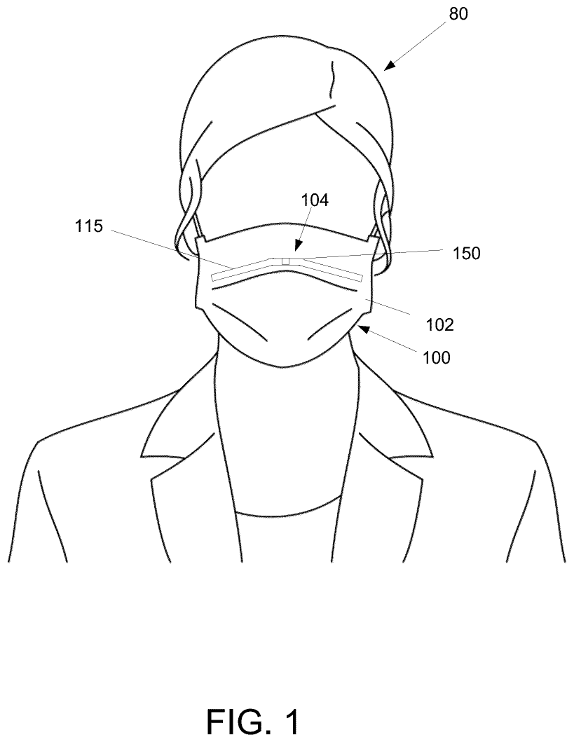

FIG. 1 is a schematic block diagram illustrating one embodiment of a system for air filtering for a user and feedback about proper usage of the system. A mask 100 is configured to mount in a variety of manners over a nose and a mouth of a user 80. The mask 100 includes a flexible mask material (filtering screen) 102 configured to move in response to breathing of the user 80. The motion of the flexible mask material 102 has a particular frequency and motion amplitude or a range of frequencies and amplitudes when the mask 100 is properly worn (i.e., sealed correctly to the face of the user 80). The mask 100 includes a sealing sensor 104 that is mounted onto the flexible mask material 102. The sealing sensor 104 includes a motion to current converter device 115 that is coupled to an output device 130. The motion to current converter device 115 is configured to generate an electrical current responsive to an experience physical force or motion. As the user is breathing, the flexible mask material 102 moves at the particular frequency and motion amplitude or within the particular range of frequencies and motion amplitudes when the mask 100 is worn properly. When the mask 100 is not worn properly, the flexible mask material 102 will only move a minimal amount due to air escaping out of unsealed sides of the mask 100, thus not allow for the motion to current converter device 115 to generate any or enough current. When the mask 100 is worn properly, the flexible mask material 102 will move due to the user 80 inhaling and exhaling. The motion of sensitive power source 115 is configured and selected to generate electric current based on motion of the flexible mask material 102 in accordance with the properly fitting mask 100. The generated electric current is used to power an output device 130 attached thereto, thus providing an indication that the user 80 is properly wearing the mask 100 (i.e., the mask 100 has a proper seal).

In various embodiments, the output device 130 may be any output device that provides a visual, audible, or sensory output. Example output devices include, but are not limited to, an illuminating device (light-emitting diode (LED)), a sound producing device (microelectromechanical systems (MEMS)) speaker, or a MEMS vibrating device.

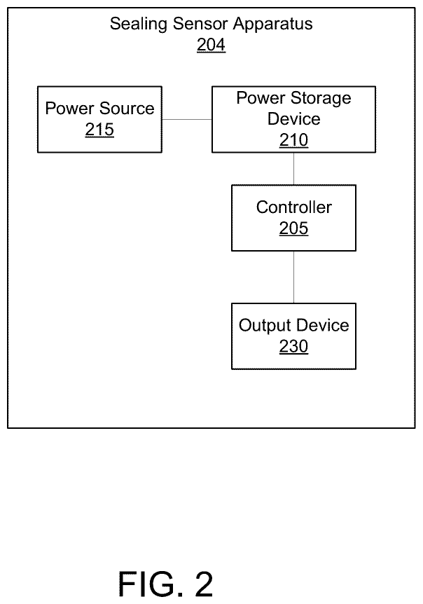

In various embodiments, as shown in FIG. 2, a sealing sensor apparatus 204 includes a controller 205, a power storage device 210, a power source 215, and an output device 230. The sealing sensor device 204 is attached to a flexible mask material, such as the flexible mask material 102 of the mask 100 shown in FIG. 1. The power source 215 may be any device that converts mechanical energy into electrical current. In one embodiment, the power source 215 is a piezoelectric element, such as a piezoelectric strip. The power source 215 converts motion that it experiences due to motion of the flexible mask material into an electric current. The power storage device 210, such as, without limitation, a capacitor, stores the electric current generated by the power source 215. In one embodiment, the controller 205 is configured to sense the amount of current stored in the power storage device 210. Once the amount of stored current reaches a threshold amount, the controller 205 allows the power storage device 210 to discharge into a closed loop circuit that also includes the output device 230, such as the output device 130 described above in FIG. 1.

In various embodiments, the controller 205 may be powered by the power source 215. The controller 205 may include a timing device configured to determine a time value since the last discharge of the power storage device 210. The sealing sensor apparatus 204 may include memory configured to store timing information. The controller 205 may include a processor (not shown) that is configured to determine if a charge stored in the power storage device 210 has reached a threshold value before expiration of a time threshold value. If the stored charge has reached the threshold value before the expiration of the time threshold value, then the controller 205 causes a switch (not shown) to close allowing the power storage device 210 to discharge to the output device 230.

In an alternate embodiment, the sealing sensor device 204 may include a battery configured to provide current to a first output device 230. If the controller 205 determines that the amount of stored charge is above a threshold or above the threshold within a time period, the controller 205 may deactivate current from the battery to the first output device 230 or may cause the power storage device 210 to discharge to a second output device (not shown). In this case, the first output device 230 may be a red LED and the second output device may be a green LED. The red LED would indicate that the mask seal is improper or not yet verified. When the red LED turns off and/or the green LED is illuminated, then a proper seal exists and/or is verified.

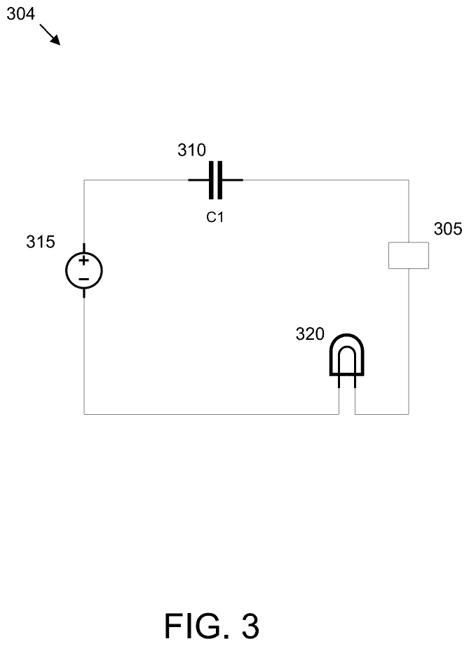

In various embodiments, as shown in FIG. 3, a closed-loop sealing sensor circuit 304 includes a piezoelectric strip 315, coupled to a capacitor 310 and an LED 320. A controller 305 is coupled between the capacitor 310 and the LED 320. Once the piezoelectric strip 315 charges the capacitor 310 to a threshold amount, the controller 305 closes the circuit 304, thus causing the capacitor 310 to discharge, sending the discharged current through the LED 320, thus producing light. These and other elements of the circuit 304 are well known generally by those having ordinary skill in the art.

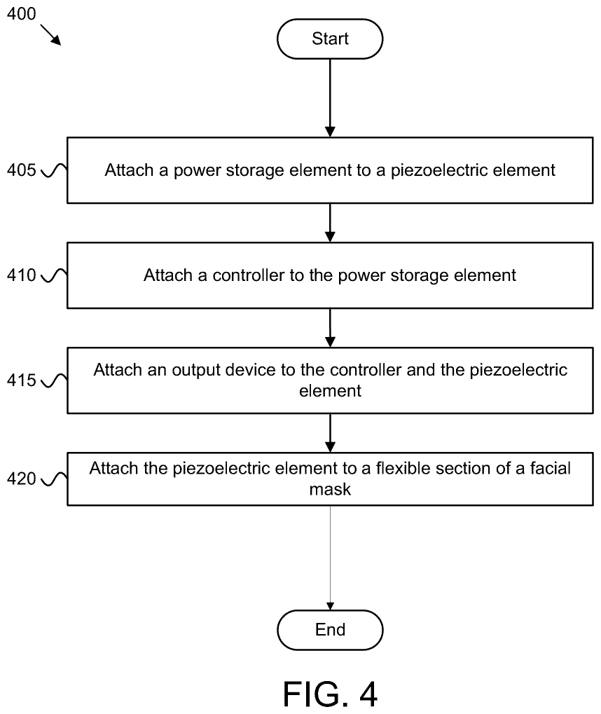

FIG. 4 is a schematic flow chart diagram illustrating an embodiment of a method 400 for forming a mask with a sealing sensor. At a block 405, a power storage element is attached to a piezoelectric element. At a block 410, a controller is attached to the power storage element. At a block 415, an output device is attached to the controller and the piezoelectric element. At a block 420, the piezoelectric element is attached to a flexible section of a facial mask.

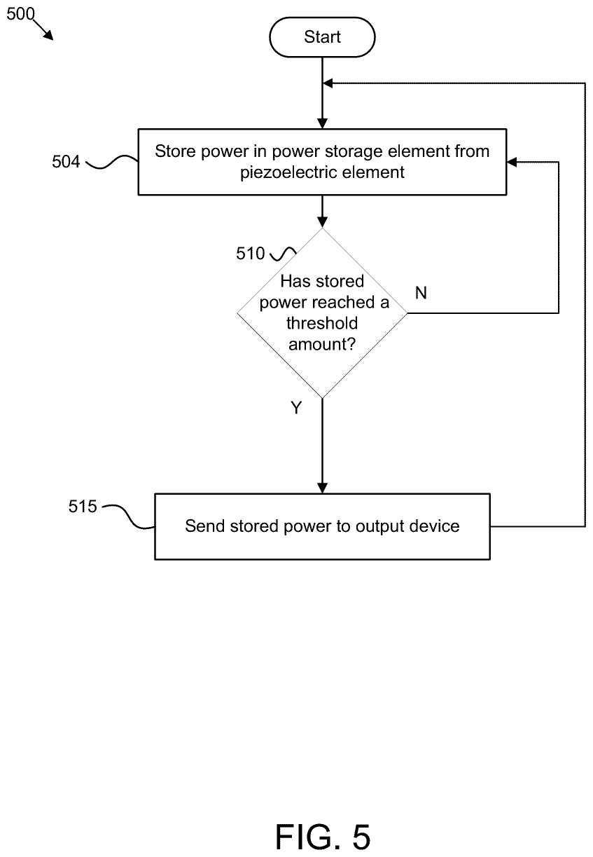

FIG. 5 is a schematic flow chart diagram illustrating an embodiment of a method 500 for providing a proper mask usage indication. At a block 504, power generated by a piezoelectric element is stored in a power storage element. At a block 504, the method 500 determines if the stored power has reached a threshold amount. If the stored power has not reached the threshold amount, the process 500 returns to the block 504. If the stored power has reached the threshold amount, the process 500 proceeds to a block 515, whereby the stored power is discharged to an output device. The process 500 returns to block 504 to repeat.

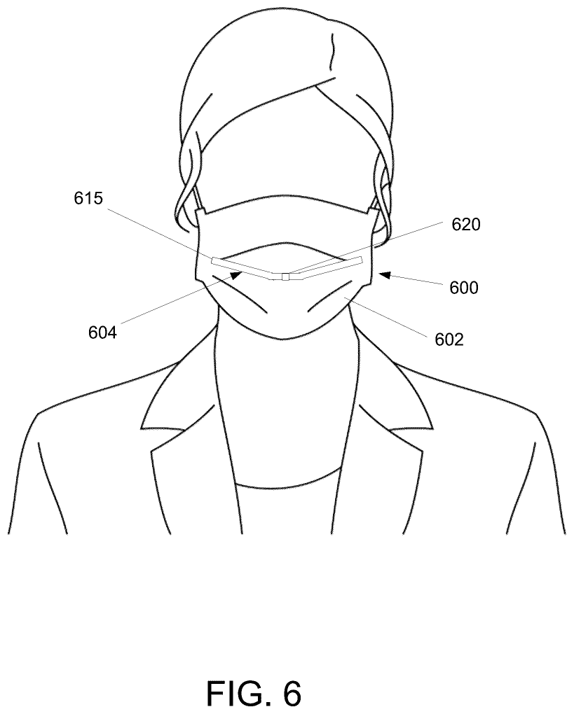

In various embodiments, as shown in FIG. 6, a sealing sensor 604 includes a power source 615 coupled to a circuit board 620 that includes a power storage device and a controller. The circuit board 620 may be made of a flexible lightweight material. The sealing sensor 604 is attached to a location on a flexible mask material 602 of a mask 600 at a location horizontally at or about a location between a chin location and a nose location of the mask 600. It can be appreciated by one of ordinary skill that the breathing sensor 6 and four may be located anywhere along the mask 600. However, locations on the flexible mask material 602 that experience the most motion as the user is inhaling and exhaling would provide better electric current production by the power source 615.

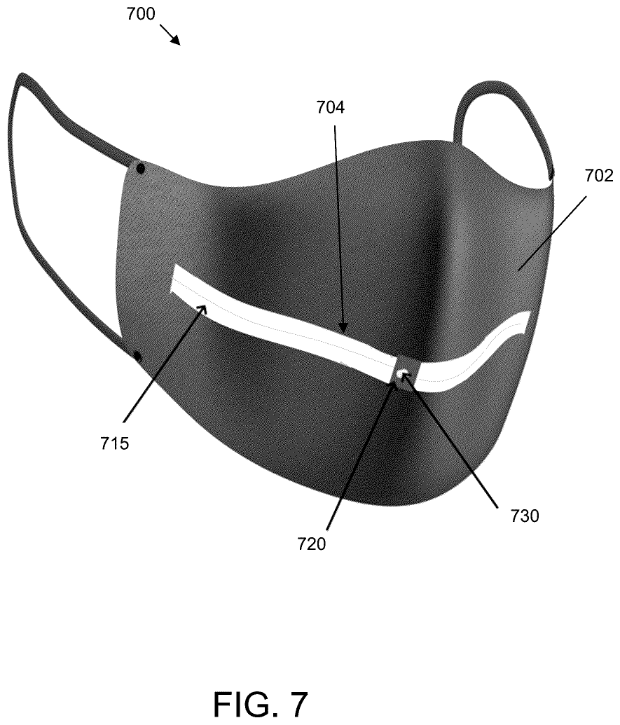

In various embodiments, as shown in FIG. 7, a mask 700 includes a form fitted flexible mask material 702 configured to fit over a user's nose mouth and chin. A breathing sensor 704 is made of a flexible piezoelectric strip 715 that is attached to a flexible circuit board 720 that includes an LED 730 and a controller (not shown). The flexible piezoelectric strip 715 includes an adhesive configured to attach to the flexible mask material 702, thus allowing the flexible piezoelectric strip 715 to conform to the shape of the mask 700.

### EMBODIMENTS

A. A mask device comprising: a flexible filtering screen configured to cover a mouth and a nose of a user; a power source disposed on the flexible filter screen; an output device configured to generate an output indication responsive to the power generated by the power source.

B. The device of A, wherein the power source comprises a piezoelectric element.

C. The device of B, wherein the piezoelectric element includes a piezoelectric strip.

D. The device of C, wherein the piezoelectric strip is attachable to a portion of the flexible fitting screen and is configured to move and generate an electric current responsive to movement of the flexible filtering screen due to breathing of the user.

E. The device of any of B-D, further comprising a power storage device configured to store electrical charge produced by the piezoelectric element.

F. The device of any of A-E, wherein the power storage device is a capacitor.

G. The device of any of A-F, further comprising a controller configured to: sense the electrical charge stored in the power storage device; and cause the power storage device to discharge responsive to the sensed electrical charge being greater than a threshold amount.

H. The device of any of A-G, wherein the output device is a light.

I. The device of H, wherein the light is a light emitting diode.

J. The device of any of A-I, wherein the output device is a speaker.

K. A method for indicating proper mask usage, the method comprising: generating an electrical current from a power source disposed on the flexible filter screen responsive to movement of the flexible filter screen; storing the generated electrical current in a storage device; discharging the stored electrical current responsive to the stored electrical current being greater than a threshold value; and outputting an indication responsive to the discharged electrical current.

L. The method of K, wherein generating the electrical current comprises generating the electrical current piezoelectrically in response to an applied force.

M. The method of any of K or L, wherein storing the generated electrical current comprises storing the generated electrical current in a capacitor.

N. The method of any of K-M, wherein outputting the indication comprises outputting the indication via a light.

O. The method of any of K-N, wherein outputting the indication comprises outputting the indication via a speaker.

P. A method for making mask device, the method comprising: attaching a power storage element to a piezoelectric element; attaching a controller to the power storage element; attaching an output device to the controller; and attaching the attached elements to a flexible section of a mask.

Q. The method of P, further comprising setting a threshold level for the controller.

R. The method of any of P or Q, wherein attaching the output device comprises attaching a light.

S. The method of R, wherein the light is a light emitting diode.

T. The method of any of P-S, wherein attaching the output device comprises attaching a speaker.

The controller/processor is capable of executing computer-readable instructions and/or capable of performing logical operations. For example, the controller/processor 202 may be a microcontroller, a microprocessor, a central processing unit (“CPU”), an auxiliary processing unit, a field programmable gate array (“FPGA”), or similar programmable controller. In some embodiments, the controller/processor executes instructions stored in a memory to perform the methods and routines described herein.

The memory, in one embodiment, is a computer readable storage medium. In some embodiments, the memory includes volatile computer storage media. For example, the memory may include a RAM, including dynamic RAM (“DRAM”), synchronous dynamic RAM (“SDRAM”), and/or static RAM (“SRAM”). In some embodiments, the memory includes non-volatile computer storage media.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A mask device comprising:
a flexible filtering screen configured to cover a mouth and a nose of a user;
a power source disposed on the flexible filter screen; and
an output device configured to generate an output indication responsive to the power generated by the power source.

2. The device of claim 1, wherein the power source comprises a piezoelectric element.

3. The device of claim 2, wherein the piezoelectric element includes a piezoelectric strip.

4. The device of claim 3, wherein the piezoelectric strip is attachable to a portion of the flexible fitting screen and is configured to move and generate an electric current responsive to movement of the flexible filtering screen due to breathing of the user.

5. The device of claim 2, further comprising a power storage device configured to store electrical charge produced by the piezoelectric element.

6. The device of claim 5, wherein the power storage device is a capacitor.

7. The device of claim 5, further comprising a controller configured to:
sense the electrical charge stored in the power storage device; and
cause the power storage device to discharge responsive to the sensed electrical charge being greater than a threshold amount.

8. The device of claim 1, wherein the output device is a light.

9. The device of claim 8, wherein the light is a light emitting diode.

10. The device of claim 1, wherein the output device is a speaker.

11. A method for indicating proper mask usage, the method comprising:
generating an electrical current from a power source disposed on the flexible filter screen responsive to movement of the flexible filter screen;
storing the generated electrical current in a storage device;
discharging the stored electrical current responsive to the stored electrical current being greater than a threshold value; and
outputting an indication responsive to the discharged electrical current.

12. The method of claim 11, wherein generating the electrical current comprises generating the electrical current piezoelectrically in response to an applied force.

13. The method of claim 11, wherein storing the generated electrical current comprises storing the generated electrical current in a capacitor.

14. The method of claim 11, wherein outputting the indication comprises outputting the indication via a light.

15. The method of claim 11, wherein outputting the indication comprises outputting the indication via a speaker.

16. A method for making mask device, the method comprising:
attaching a power storage element to a piezoelectric element;
attaching a controller to the power storage element;
attaching an output device to the controller; and
attaching the attached elements to a flexible section of a mask.

17. The method of claim 16, further comprising setting a threshold level for the controller.

18. The method of claim 16, wherein attaching the output device comprises attaching a light.

19. The method of claim 18, wherein the light is a light emitting diode.

20. The method of claim 16, wherein attaching the output device comprises attaching a speaker.
